(19) United States
(12) Patent Application Publication
(10) Pub. No.: US 2026/0085831 A1
(43) Pub. Date: Mar. 26, 2026

(54) Multi-Functional Key Chain with Programmable Slogan

(71) Applicant: Lynnette Fortune, Philadelphia, PA (US)

(72) Inventor: Lynnette Fortune, Philadelphia, PA (US)

(21) Appl. No.: 19/221,840

(22) Filed: May 29, 2025

Related U.S. Application Data
(60) Provisional application No. 63/698,068, filed on Sep. 24, 2024.

(51) Int. Cl. F21V 33/00; A44B 15/00; F21L 4/02; F21V 23/04; F21Y 115/10; G09F 9/30; G09F 13/18; G09F 21/02

(52) U.S. Cl. CPC F21V 33/0004; A44B 15/00; F21L 4/02; F21V 23/04; G09F 9/30; G09F 13/18; G09F 21/02; F21Y 2115/10

(57) ABSTRACT

The present invention relates to a keychain device designed to provide illumination and personalization. The device includes a body shaped as a vehicle silhouette and a plurality of LED lights powered by a button-cell battery. A microcontroller is operably connected to the LED lights and controls various lighting patterns and button press functions. The device includes a programmable display for displaying a customizable slogan, which can be altered to customize the keychain device. Bluetooth functionality allows users to customize both the slogan and LED light colors using a smartphone application. The device also includes a button for activating the LED lights, with different press functions for varying brightness or energy-saving modes. Additionally, the keychain body is coated with phosphorescent material to glow the device in the dark even when the LEDs are inactive.

### CROSS-REFERENCE TO RELATED APPLICATION

The present application claims priority to, and the benefit of, U.S. Provisional Application No. 63/698,068, which was filed on Sep. 24, 2024, and is incorporated herein by reference in its entirety.

### FIELD OF THE INVENTION

The present invention generally relates to keychain devices. More specifically, the invention relates to a light-up keychain device designed to enhance safety and personalization. The device comprises a durable body in the shape of a vehicle silhouette, embedded with energy-efficient LED lights powered by a button-cell battery. The device features a programmable display for customizable slogans, which illuminate when the LED lights are activated. The device also includes a phosphorescent coating for glow-in-the-dark functionality and Bluetooth connectivity for wireless customization of the slogan and lighting options through a smartphone application. Accordingly, this disclosure makes specific reference thereto the present invention. Nonetheless, it is to be appreciated that aspects of the present invention are also equally applicable to other like applications, devices, and methods of manufacture.

### BACKGROUND

In today's world, personal safety has become a significant concern, particularly when individuals find themselves alone, either driving or walking, especially at night or in dimly lit environments. Poor lighting in such conditions poses several risks, making everyday tasks more challenging and potentially dangerous. For instance, a lack of visibility can lead to tripping over unseen obstacles, struggling to find keyholes, or even heightening the overall sense of vulnerability that comes with being in the dark. This discomfort often extends beyond mere inconvenience, as it can cause considerable anxiety, leaving people on edge or feeling uneasy until they reach a more secure, well-lit location.

Traditionally, people have relied on their smartphones for quick illumination, using them as makeshift flashlights in these scenarios. However, accessing a phone is not always a viable option. In certain situations, retrieving the phone might be inconvenient, unsafe, or impractical—such as when the individual's hands are full, or when there's an urgent need for immediate light. Additionally, smartphones, though widely available, are frequently overused throughout the day for various tasks, leaving their batteries drained when a quick source of light might be needed most. Consequently, there is an unmet need for an alternative, convenient source of illumination that individuals can depend on, without worrying about phone accessibility or battery life.

Therefore, there exists a long-felt need in the art for a light-up keychain device that not only serves as a functional key holder but also enhances personal safety by providing reliable illumination in low-light environments. There is a long-felt need for a keychain device that incorporates energy-efficient lighting to help users locate their keys, keyholes, or navigate in the dark. Additionally, there is a long-felt need for a customizable keychain that allows users to personalize it with slogans, colors, and designs to reflect their unique preferences. Moreover, there is a long-felt need for a keychain that can integrate with modern technology, offering Bluetooth connectivity for customization and tracking purposes. Finally, there is a long-felt need for a keychain that is durable, easy to use, and aesthetically pleasing, offering both functionality and personalization to users in various contexts, including everyday use and branding purposes.

The subject matter disclosed and claimed herein, in one embodiment, comprises a light-up keychain device. The device includes a durable body in the shape of a vehicle silhouette or miniature car model which is embedded with energy-efficient LED lights powered by a button-cell battery. The keychain also features a programmable display space that can be customized with a slogan or phrase which is illuminated when the LED lights are activated. A phosphorescent coating allows the device to glow in the dark after exposure to light providing additional visibility even when the LED lights are off. Furthermore, the keychain is equipped with Bluetooth connectivity, allowing users to wirelessly customize the slogan and LED lighting options through a smartphone application, and also to locate the keychain if lost.

In this manner, the light-up keychain device of the present invention accomplishes all of the foregoing objectives, providing a multifunctional keychain that enhances personal safety by illuminating dark environments while offering customization features for user personalization. The device offers a solution to standard keychains by combining advanced lighting technology with a programmable slogan display, providing both practical benefits and aesthetic appeal. The phosphorescent material provides visibility even without battery power, enhancing the overall functionality and reliability of the keychain.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminating and personalized keychain device. The keychain device comprises a body in the shape of a vehicle silhouette or miniature car model. A plurality of energy-efficient LED lights are embedded within the body. A button-cell battery is disposed of within the body and is configured to supply electric energy to the plurality of LED lights. A button is placed on the surface of the body and is operably connected to the plurality of LED lights, wherein pressing the button activates the LED lights. A programmable space is disposed on the body for displaying a customizable slogan or phrase. A phosphorescent material is coated on the body and is configured to glow in the dark after being exposed to light.

In another aspect, a light-up keychain device is disclosed. The light-up keychain device includes a body, a plurality of energy-efficient LED lights embedded within the body, a button is disposed on the body, operably connected to the LED lights, wherein pressing the button activates the LED lights and a double-tap of the button switches the LED lights to a dimmer, energy-saving mode, a programmable display for showing a customizable slogan or phrase, wherein the display is configured to be illuminated when the LED lights are activated, and a Bluetooth module for wireless communication with a smartphone, enabling customization of the slogan and the illumination patterns of the LED lights, and for locating the keychain via the smartphone.

In another embodiment, a light-up keychain device is disclosed. The light-up keychain device includes a body in the shape of a vehicle silhouette, a plurality of multi-color LED lights embedded within the body, the multi-color LED lights are configured to illuminate in different colors based on user selection, a first button is disposed on the body and is operably connected to the plurality of LED lights, wherein pressing the first button activates the multi-color LED lights, a programmable space displays a customizable slogan, a Bluetooth module enables wireless communication with an external device allowing remote customization of the multi-color LED lights and slogan displayed on the keychain, and a second button is disposed on the body, wherein pressing the second button activates a flashing LED light at the front end of the body, functioning as a torch.

In another embodiment, a customized and glowing keychain device is disclosed. The keychain device includes a plurality of LED lights, a button-cell battery configured to power the LED lights, a microcontroller operably connected to the LED lights, configured to control lighting patterns and button press functions, a button disposed on the body and operably connected to the microcontroller, wherein pressing the button activates the LED lights, a programmable display for displaying a customizable slogan, a Bluetooth module configured for wireless communication with an external device to customize the slogan and LED light colors, and a phosphorescent material coating the body and configured to glow in the dark after exposure to light.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of light-up keychain device in accordance with one embodiment of the present invention;

FIG. 2 illustrates a schematic view showing communication of the illuminating and personalized keychain device of the present invention with a smartphone application in accordance with the disclosed structure;

FIG. 3 illustrates a perspective view of another embodiment of the keychain device of the present invention in accordance with the disclosed structure; and

FIG. 4 illustrates a block diagram view of the electronic components used in the keychain device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a light-up keychain device that not only serves as a functional key holder but also enhances personal safety by providing reliable illumination in low-light environments. There is a long-felt need for a keychain device that incorporates energy-efficient lighting to help users locate their keys, keyholes, or navigate in the dark. Additionally, there is a long-felt need for a customizable keychain that allows users to personalize it with slogans, colors, and designs to reflect their unique preferences. Moreover, there is a long-felt need for a keychain that can integrate with modern technology, offering Bluetooth connectivity for customization and tracking purposes. Finally, there is a long-felt need for a keychain that is durable, easy to use, and aesthetically pleasing, offering both functionality and personalization to users in various contexts, including everyday use and branding purposes.

The present invention, in one exemplary embodiment, is a light-up keychain device. The light-up keychain device includes a body in the shape of a vehicle silhouette, a plurality of multi-color LED lights embedded within the body, the multi-color LED lights are configured to illuminate in different colors based on user selection, a first button is disposed on the body and is operably connected to the plurality of LED lights, wherein pressing the first button activates the multi-color LED lights, a programmable space displays a customizable slogan, a Bluetooth module enables wireless communication with an external device allowing remote customization of the multi-color LED lights and slogan displayed on the keychain, and a second button is disposed on the body, wherein pressing the second button activates a flashing LED light at the front end of the body, functioning as a torch.

Reference will now be made in detail to the present preferred embodiments of the invention, examples of which are illustrated in the accompanying drawings. Wherever possible, the same reference numerals are used in the drawings and the description to refer to the same or like parts.

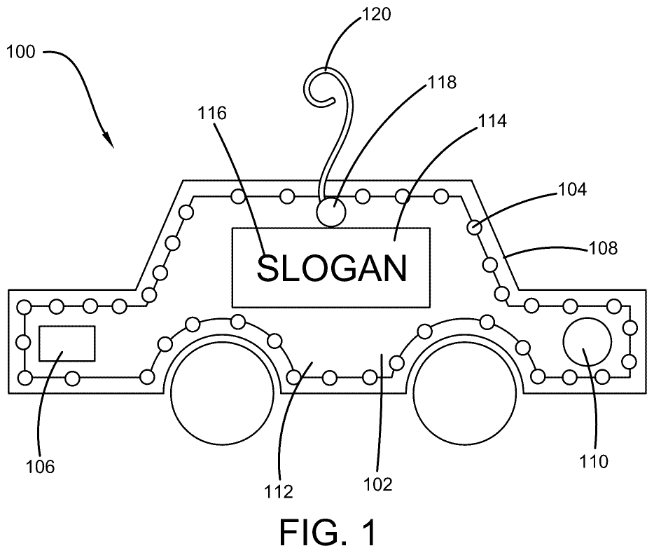

Referring initially to the drawings, FIG. 1 illustrates a perspective view of light-up keychain device 100 in accordance with one embodiment of the present invention. The multi-functional keychain with programmable slogan 100 of the present invention is designed as an illuminating keychain to help people feel safer while driving or walking. The keychain device 100 combines functionality of a conventional keychain and personalization using a customized shape and slogan. More specifically, the keychain device 100 is preferably in (but not limited to) the shape of a car motif, vehicle silhouette or miniature car model body 102. The body 102 is made of durable materials like plastic or metal to withstand everyday use. The keychain device 100 includes a plurality of energy-efficient LED lights 104 embedded within the body 102. A small button-cell battery 106 is disposed in the keychain device 100 to supply electric energy to the LED lights 104. The LED lights 104 are preferably integrated along the periphery 108 of the body 102 and a small button 110 is placed on the top surface 112 of the keychain body 102 allowing users to activate the LED lights 104 when the button 110 is pressed. The button 110 can be integrated into the car design or appear as a distinct part, such as but not limited to a headlight or dashboard button.

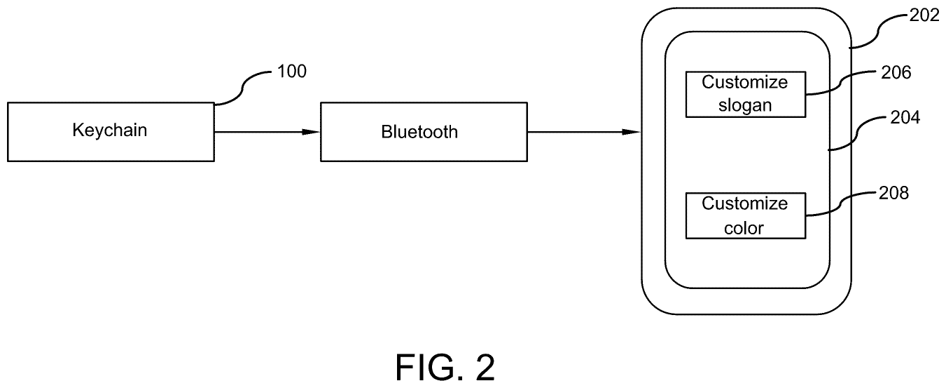

The multi-functional keychain 100 includes a designated programmable space 114 for a slogan or phrase 116. The slogan 116 can be personalized according to the preferences of users as described in FIG. 2. The designated programmable space 114 can be in the form of an engraved plate, a printed surface, or an embedded digital display. When the button 110 is pressed, the slogan 116 is also illuminated to become visible when the device 100 lights up. In the preferred embodiment, the slogan 116 on the keychain 100 is made using laser engraving or UV printing.

At least one aperture 118 is disposed in the body 102 and is used for engaging a hook 120. The hook 120 is used for accommodating one or more keys for providing functionality of a conventional keychain device. The device 100 functions as a regular keychain and provides a convenient way to carry keys with added aesthetic and functional benefits like illumination and personalized messaging.

The keychain 100 is coated or made with phosphorescent material that allows the keychain 100 to glow in the dark after being exposed to light. The phosphorescent material allows the keychain 100 to glow in the dark even when the LEDs do not work or the battery 106 is drained. The phosphorescent material absorbs light energy during the day or under ambient lighting and emits light in low-light environments. In one embodiment, a long press on the button 110 can trigger brighter lighting for a set duration and a double-tap on the button 110 can switch the LEDs 104 to dimmer, energy-saving mode.

FIG. 2 illustrates a schematic view showing communication of the illuminating and personalized keychain device 100 of the present invention with a smartphone application in accordance with the disclosed structure. In the present embodiment, the keychain 100 can include Bluetooth technology which connects the keychain 100 to a remote device 202 such as a smartphone for communication with the smartphone application 204. The application 204 provides a “Customize slogan” option 206 for customizing digital slogan displayed on the keychain 100. The option 206 allows personalization of the keychain 100 and users can also define their own slogans. A “Customize color” option 208 allows users to customize illuminating color options for LEDs 104. The Bluetooth technology can also be used for locating the keychain if lost.

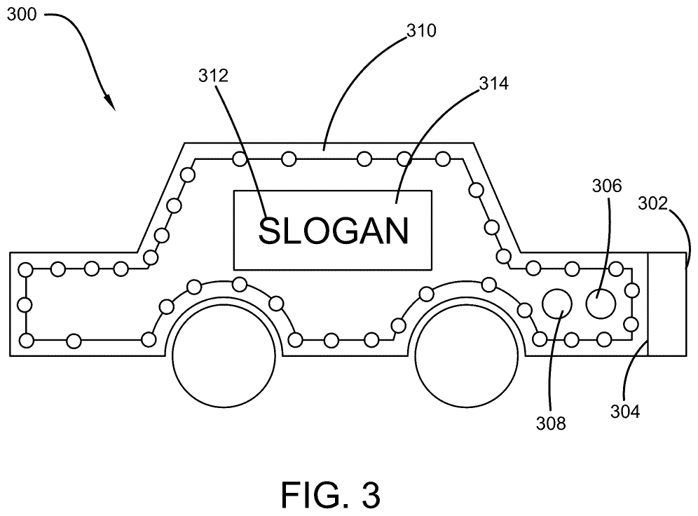

FIG. 3 illustrates a perspective view of another embodiment of the keychain device 100 of the present invention in accordance with the disclosed structure. In the present embodiment, the keychain device 300 includes a flashing LED 302 disposed at the front end 304 of the device 300. The LED 302 is coupled for a first button 306 wherein the button 306 when pressed, activates the LED 302 which functions as an illumination device that helps users to navigate in the dark.

A second button 308 is disposed in the device 300 and is coupled to multi-color LEDs 310 and slogan 312. When the button 308 is pressed, the LEDs 310 and the slogan 312 are illuminated or glowing. The multi-color LEDs are adapted to change color based on user selection or pre-set patterns providing more customization options to the users. The programmable slogan space 314 allows endless customization of the keychain 300 without needing to physically alter the device 300.

The keychain devices 100,300 of different embodiments can be used by individuals to enhance the visibility of their keys, making it easier to locate them in the dark. The keychains 100,300 help individuals feel safer while driving or walking and allows people to customize the slogan or phrase that illuminates. The keychain device can be used by companies by customizing the slogans with logos or advertising messages, thereby making the keychains for branding and promotional giveaways.

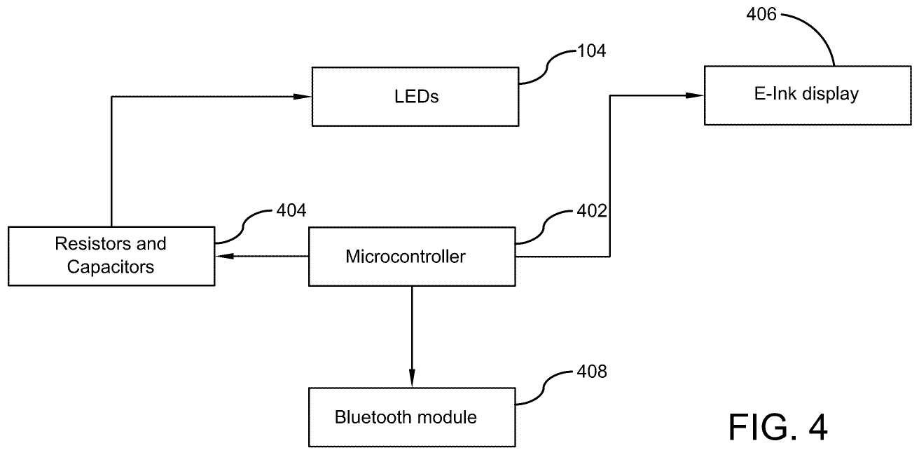

FIG. 4 illustrates a block diagram view of the electronic components used in the keychain device 100 of the present invention in accordance with the disclosed structure. A small, low-power microcontroller 402 functions as the “brain” of the keychain and is adapted to control all the other electronic components thereof. The microcontroller 402 manages functions like lighting patterns, button press detection, and connectivity to external devices (such as a remote device). A plurality of resistors and capacitors 404 help regulate the current flow from the battery and provide stable voltage to the LEDs, microcontroller, and other components. A small, low-power E-Ink display 406 is configured to display customizable text or slogans. E-Ink provides a low-power option that only uses energy when the display changes. A Bluetooth module 408 enables wireless communication with a smartphone or other devices. The module 408 allows remote control of lighting patterns of LEDs or sending/receiving data like keychain location or message updates.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-functional keychain with programmable slogan”, “multi-functional keychain”, “keychain device”, “light-up keychain device”, “illuminating and personalized keychain device”, and “keychain” are interchangeable and refer to the multi-functional keychain device 100,300 of the present invention.

Notwithstanding the forgoing, the multi-functional keychain device 100,300 of the present invention can be of any suitable size and configuration as is known in the art without affecting the overall concept of the invention, provided that it accomplishes the above stated objectives. One of ordinary skill in the art will appreciate that the multi-functional keychain device 100,300 as shown in the FIGS. are for illustrative purposes only, and that many other sizes and shapes of the multi-functional keychain device 100,300 are well within the scope of the present disclosure. Although the dimensions of the multi-functional keychain device 100,300 are important design parameters for user convenience, the multi-functional keychain device 100,300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A keychain device comprising:
a body;
a plurality of LED lights disposed within the body arranged along a periphery of the body;
a button configured to activate the plurality of LED lights;
a programmable space on the body for displaying a customizable slogan;
a battery disposed within the body for powering the plurality of LED lights;
wherein the programmable space is illuminated when the button is pressed, and
wherein the body includes an aperture for engaging a hook.

2. The keychain device of claim 1, wherein the body is in the shape of a car motif, a vehicle silhouette, or a miniature car model.

3. The keychain device of claim 1, wherein the programmable space comprises an engraved plate, a printed surface, or a digital display.

4. The keychain device of claim 1 further comprised of a Bluetooth Module.

5. The keychain device of claim 1, wherein the button is located on a top surface of the body.

6. The keychain device of claim 3, wherein the programmable space is customized using a laser engraving or a UV printing.

7. A keychain device comprising:
a body made of a phosphorescent material and an aperture;
a plurality of LED lights disposed within the body, the plurality of LED lights being arranged to illuminate the body when activated;
a first button configured to activate the plurality of LED lights;
a programmable space for displaying a customizable slogan; and
a battery configured to power the plurality of LED lights.

8. The keychain device of claim 7 further comprised of a second button.

9. The keychain device of claim 7, wherein the second button is configured to change a lighting pattern or an intensity of the plurality of LED lights.

10. The keychain device of claim 7 further comprised of a programmable digital display.

11. The keychain device of claim 7, wherein the programmable digital display displays the customizable slogan.

12. The keychain device of claim 7, wherein the body is in the shape of a car motif, a vehicle silhouette, or a miniature car model.

13. The keychain device of claim 7, wherein the body is comprised of a plastic material.

14. A keychain device comprising:
a body;
a plurality of LED lights disposed within the body;
a button for controlling the plurality of LED lights, wherein a single press of the button activates the plurality of LED lights and a double press switches the plurality of LED lights to an energy-saving mode;
a programmable display for showing a customizable slogan;
a Bluetooth module integrated into the body for wirelessly communicating with a remote device;
a battery disposed within the body for powering the LED lights and the Bluetooth module; and
wherein the programmable display is configured to be customized via the remote device.

15. The keychain device of claim 14, wherein the body is comprised of a metal material.

16. The keychain device of claim 14, wherein the plurality of LED lights can flash.

17. The keychain device of claim 14, wherein the plurality of LED lights can change colors.

18. The keychain device of claim 14 further comprised of a microcontroller.

19. The keychain device of claim 14, wherein the body is in the shape of a car motif, a vehicle silhouette, or a miniature car model.

20. The keychain device of claim 14, wherein the customizable slogan can be illuminated by the plurality of LED lights.
